(19) United States
(12) Patent Application Publication
(10) Pub. No.: US 2009/0083614 A1
(43) Pub. Date: Mar. 26, 2009

(54) System and method for optimizing information display in spreadsheets and tables

(75) Inventor: Gerald A. Wedekind, Rancho Palos Verdes, CA (US)

Correspondence Address: Xerox Corporation (CDFS), 445 Broad Hollow Rd.-Suite 420, Melville, NY, 11747, US

(73) Assignee: Xerox Corporation

(21) Appl. No.: 11/904,193

(22) Filed: Sep. 26, 2007

(51) Int. Cl. G06F 15/00; G06F 17/00

(52) U.S. Cl. 715/217; 715/227

(57) ABSTRACT

Disclosed is a system and method for reducing the size of a tabular display, such as a spreadsheet or dynamically formatted table. Global optimization techniques, for example, simulated annealing, are used to identify an optimal or near-optimal set of column widths whereby the width of columns having cells containing greater amounts of text are increased while the width of columns having cells containing smaller amounts of text are correspondingly decreased, thus reducing overall table height without changing net table width. Use of global optimization avoids converging upon local minimum solutions in favor of solutions which are optimal or near-optimal. By reducing table height, readability is enhanced, and efficiencies are realized which result in reduced costs and reduced consumption of resources. Reductions in table width, as well as conformance of table size to a target aspect ratio are also disclosed.

### BACKGROUND

The present disclosure relates to the field of computer data processing, and more particularly, to a system and method for optimizing a tabular display, typically seen in spreadsheets, interactive table editors, and dynamic table generators, by automatically adjusting the widths of the columns so as to minimize total table height.

Spreadsheets have become one of the most widely-used computer software applications, particularly in the business, financial and scientific fields. Using a spreadsheet, a user can enter data and data relationships into cells arranged as a table with rows and columns, and then analyze, manipulate and print those numbers using the table structure. Each row and column may include one or more labels that identify or describe the data contained within each respective row or column, and clarify the structure and purpose of the spreadsheet. Often, the spreadsheet user will perform an iterative analysis by changing the data in one or more cells, observing the effects of the change, and continuing with subsequent “what if” scenarios until a desired result is obtained. Other capabilities commonly found in spreadsheets include the ability to display text with a variety of font attributes; to import and export data in numerous formats, such as tab-delimited text, fixed width text, or as a database; to generate and display charts, graphs and other visual representations of spreadsheet data, such as pie charts, histograms or scatter charts; and to automate tasks with macros and/or scripting languages such as Java or VBA.

Beyond spreadsheets, the ability to interactively manipulate tabular data exists within other forms of software applications as well. For example, word processing, desktop publishing and page-layout applications all typically contain a table editor for neatly formatting text and other design elements into rows and columns. Web applications, popularly referred to as “webapps”, are accessed using a web browser over a data network such as the Internet and can also provide the ability to interactively manipulate tabular data.

Another class of table-oriented software programs are known as dynamic table formatters. Dynamic table formatters provide the ability to define visual aspects of a tabular report separately from the report's content; to store the design for future use; and to dynamically generate the report in accordance with the stored design in response to the requirements of a recipient. Commonly, dynamic table formatters are used to generate pages containing tabular data such as, for example, bills, invoices, financial statements, and product offerings. Such pages can be rendered as web pages, as digital files such as PDF files, or in traditional print media.

Still another class of table-oriented software programs and devices are tailored to deliver real-time tabular data to video displays, such as airport arrival and departure displays and financial market and trading floor displays. Tabular data is also commonly displayed by systems which perform video compositing of text over other graphic elements, as is popular in all forms of video production and television broadcasting, including for example news broadcasts and sporting event broadcasts, where statistics, competitor information, graphics and the like are superimposed over raw video. Such systems are capable of real-time compositing of tabular data during live broadcasts, and additionally or alternatively, during post-production editing.

Large spreadsheets, tables created with interactive editing tools, dynamically-formatted tabular documents and video displays often contain a complex mix of information which the user would like to display or print as compactly as possible in order to, for example, maximize the amount of information presented, enhance comprehension, decrease display times, and to reduce printing and mailing costs. One approach to creating a more compact table is to decrease its height. A user can achieve this result by tailoring column widths such that columns having cells containing more voluminous data (such as wrapped, multi-line text) are widened, thereby decreasing the row height, and conversely, more sparsely-populated columns are narrowed to reduce or eliminate unused areas (sometimes referred to as whitespace). While the relative widths of the columns may change, the net width of the table remains constant as table height decreases.

To follow this approach manually using a table editor such as a spreadsheet, a user must adjust column widths using trial and error. For example, a typical manual strategy might be to attack the column which contains the cell having the greatest height (known as the “long pole” column) by widening that column by some increment such that the table's overall height is reduced. Then, at least one other column is identified having enough heightwise “slack” so that reducing its width by the same increment doesn't negate the reduction in table height just achieved. This process is then repeated with the next long pole column and continues until a satisfactory solution is achieved.

In more detail, the user faces a set of “long pole” cells (namely, the cells in each row with the largest required height) whose height can only be manipulated (a) indirectly, by adjusting the width of the containing column; (b) in groups, where all cells in one column must be changed as a unit; and (c) subject to the constraint that every width increase must be accompanied by offsetting width decreases elsewhere. It will be readily appreciated that dealing manually with these complications becomes an increasingly onerous and frustrating task as table size and complexity increases

Moreover, when spreadsheet or table contents change, such as the importation of new or additional data, the deletion of cells, or an iteration of a “what if” analysis, the entire process may need to be repeated.

In the case where dynamically-formatted reports are generated, manual optimization is impractical or even impossible. This is especially true where many thousands, or even millions, of documents are created in a batch mode, such as the billing run of a public utility or credit card issuer. An organization's ability to achieve optimal, or near-optimal, minimization of pages printed in a large-scale printing run can yield significant reductions in costs and consumption of resources, with attendant benefits accruing to the organization, the consumer, and to the environment.

It would be desirable to have the ability to automatically perform the described column width manipulation to reduce the size of a tabular display. What is needed, then, is a system and method for reducing the size of tabular representations of data by automatically optimizing the sizes of the columns and/or rows of the table.

### SUMMARY

It is an aspect of this disclosure to provide a system and method for optimizing a tabular display by automatically adjusting the widths of the columns so as to minimize total table height. In particular, an optimize column widths system and method is disclosed wherein a global optimization technique, such as simulated annealing, is employed to vary individual column widths of a tabular display to optimize the display for minimum table height.

“Optimization algorithms” refer to a class of algorithms which, given a set of allowed states, seek to optimize (i.e. minimize or maximize) a function that is dependent upon the state. Generally, such an algorithm will evaluate this dependent function at some initial state, make a change to the state, evaluate the dependent function at the new state, and either “move to” the new state or not depending upon the magnitude and direction of change in the dependent function value, and possible also upon additional algorithm-specific factors. The algorithm iteratively repeats until some end state is reached.

For example, the dependent function can be the height of a spreadsheet table, and the state of interest can be the combination of column widths of the spreadsheet. Table height is also affected by a number of appurtenant factors; such as the table's cell contents, font sizes, font formatting, and overall width, which are chosen by the table's creator. In this scenario, a simple optimization algorithm might increase the width of one column and correspondingly decrease the width of another; determine whether the spreadsheet height decreased as a result of the change; and if it decreased, save the new set of column sizes; then try another iteration. The end state is reached after, for example, a certain finite number of iterations have transpired, or after a certain period of time has elapsed.

Such simple optimization algorithms are known to be susceptible to the local optimum problem, in which the algorithm converges upon a locally optimum solution which is proximally located to the initial state, yet may be suboptimal when viewed in the context of the universe of allowed states.

Simulated annealing is a global optimization algorithm which seeks to avoid the local optimum problem using a heuristic approach inspired by the physical process of annealing. Applied to the table layout problem, simulated annealing might work as follows: Given an initial set of table widths, a change is made to the widths of two randomly chosen columns whereby one column is increased by an amount and a second decreased by the same amount. When evaluating the dependent function, such as the height of a spreadsheet, all moves that result in a decrease in the function's value are accepted. However, simulated annealing will occasionally accept modified states which increase the height. Such moves are accepted with a probability that decreases over successive iterations of the algorithm, as controlled by a parameter known as “temperature.” More of such moves are accepted at higher values of temperature than at lower values. Much like actual annealing, the simulated annealing algorithm starts with a high value of temperature that gradually decreases. In this manner, moves that increase table height have a progressively lower probability of being accepted until finally, the temperature decreases to such a low value that only moves that reduce table height are accepted. Metaphorically equating table height to altitude, the high early temperatures enable the algorithm to more effectively explore the global landscape by “climbing out” of high valleys into lower ones, while the lower final temperature allows the algorithm to converge to the bottom of the valley which was ultimately settled upon. In this way, the algorithm typically converges to an optimal, or a near-optimal “good enough”, solution.

In one embodiment contemplated by the present disclosure, an optimization module implementing the simulated annealing optimization algorithm is incorporated within the executable spreadsheet software. It is envisioned that the optimization module can be activated manually, by using user interface elements such as a menu selection, button, gesture or other user interface device which will be familiar to the skilled artisan. It is also envisioned that the optimization algorithm can be activated automatically wherein row or column sizes are automatically optimized in real-time as table contents are changed.

Other parameters relating to the execution and operation of the optimization module can also be exposed via the user interface, again using suitable user interface elements, to permit the user to customize optimization. For example, the user can select among preset parameter sets, such as “best” optimization, “fast” optimization, or a “normal” setting representing a balanced compromise between speed and quality. Additionally or alternatively, lower-level simulated annealing parameters such temperature, rate of temperature change, number of iterations and other parameters can be exposed for manipulation via the user interface. At least one such set of user-specified parameters can be stored as an optimization profile enabling the user to quickly recall previously-saved settings as required.

In an envisioned embodiment of present disclosure, an optimization module implementing the simulated annealing optimization algorithm is contained within a software extension component, such as a script, macro, dynamic link library (DLL), plug-in or snap-in, that extends the capabilities of another product, for example, a spreadsheet, dynamic report generator, web application framework, or video effects generator.

It is a further aspect of the present disclosure, that, after achieving a solution, the results are updated directly to the tabular display. Alternatively, user input can be solicited to determine whether to update the tabular display with the optimized column widths, to keep the table as-is (with its original set of display widths) or additionally or alternatively, to re-execute the optimization with different settings. Such settings can be chosen at the user's discretion, or can be suggested by the software based upon criteria such as table attributes and/or system resources.

It is contemplated that, in certain cases, it may be desirable to optimize not the height, but rather, the width of a table, therefore another aspect of the present disclosure provides a system and method for optimizing the width of a tabular display by automatically adjusting the height of the table rows. Yet another aspect of the disclosure provides for comprehensive table size optimization wherein both column widths and row heights are automatically adjusted to minimize table area, and additionally or alternatively, optimized in conformance with a target aspect ratio. It is further envisioned that optimization can be limited to a specified subset of the table's rows and/or columns, which can be activated, by example, by choosing an “Optimize Selection” menu command.

The optimization of tabular display height is now presented in the form of a global optimization problem. Assuming a table with r rows and c columns; wᵢ for i=0, . . . , c−1 is the width of column i, so that

$${\sum }_{i = 0}^{c - 1} {w}_{i} = W$$

is the table's width (which is to remain fixed; and hⱼ(w₀, . . . , w_{c-1}) for j=0, . . . , r−1 is the height of row j (i.e. the minimum height which row j can have and still allow all text in row j to remain visible), so that

$${\sum }_{j = 0}^{r - 1} {h}_{j} = H$$

is the table's required height. The reader will note that the hⱼ (and thus H) are functions of the column widths wᵢ. What is desired is the set of column widths woptᵢ which minimize the table height without changing its width, i.e., such that

$$\begin{matrix}{\sum }_{i = 0}^{c - 1} {wopt}_{i} = W and H ( {wopt}_{0} , … , {wopt}_{c - 1} ) \\ = {\sum }_{j = 0}^{r - 1} {h}_{j} ( {wopt}_{0} , … , {wopt}_{c - 1} ) \\ = {min}_{{\sum }_{{w}_{i} = W}} {\sum }_{j = 0}^{r - 1} {h}_{j} ( {w}_{0} , … , {w}_{c - 1} )\end{matrix}$$

or, since the height required by a row is the largest height required by any of its cells,

$$\begin{matrix}H ( {wopt}_{0} , … , {wopt}_{c - 1} ) = {\sum }_{j = 0}^{r - 1} {max}_{i} ( {h}_{ij} ( {wopt}_{i} ) ) \\ = {min}_{{\sum }_{{w}_{i} = W}} {\sum }_{j = 0}^{r - 1} {max}_{i} ( {h}_{ij} ( {w}_{i} ) ) ,\end{matrix}$$

where hᵢⱼ (wᵢ) is the required height of cell (i,j) as a function of its width wᵢ.

The problem of finding a minimum, or near-minimum “good enough”, table height has thus been reduced to a search for the global minimum of the function H (the table height) over the (c−1)-dimensional space of column width combinations wᵢ having the constant sum W.

A method of minimizing the height of a tabular display is disclosed which includes determining the initial height of the table; establishing conditions indicating an end state; establishing an initial value of a temperature parameter; changing the widths of at least two columns whereby at least one column is increased by an amount and at least one column second decreased by an amount such that the net width of the table is unchanged; determining the new height of the table and if the height has decreased, accepting the new set of column widths; or if the height has increased, accepting the new set of column widths in accordance with a transition probability function, said transition probability function providing for a decreasing probability of acceptance as the value of temperature decreases; and proceeding with subsequent iterations having a successively lower value of temperature, until the end state is reached.

The present disclosure also provides a computer-readable medium storing a set of programmable instructions configured for being executed by at least one processor for performing a method of minimizing the height of a tabular display in accordance with the present disclosure.

### BRIEF DESCRIPTION OF THE DRAWINGS

Various embodiments of the present disclosure will be described herein below with reference to the figures wherein:

FIG. 1 is a block diagram illustrating a representative operating environment for an exemplary embodiment in accordance with the present disclosure;

FIG. 2A is a block diagram illustrating an exemplary embodiment in accordance with the present disclosure

FIG. 2B is a block diagram illustrating an exemplary embodiment in accordance with the present disclosure

FIG. 3 is an exemplary flow diagram illustrating a method for optimizing table column widths in accordance with the present disclosure;

FIG. 4A illustrates an exemplary user interface in accordance with the present disclosure;

FIG. 4B illustrates an exemplary user interface in accordance with the present disclosure;

FIG. 5A illustrates an exemplary tabular display in an initial state in accordance with the present disclosure; and

FIG. 5B illustrates an exemplary tabular display after one optimization iteration in accordance with the present disclosure; and

FIG. 5C illustrates an exemplary tabular display after two optimization iterations in accordance with the present disclosure.

### DETAILED DESCRIPTION

The present disclosure provides a system and method for automatically adjusting the dimensions of the columns and/or rows of a tabular display by global optimization means to minimize the table height, the table width, or both the table height and table width, of the tabular display, which is now described in detail with reference to the Figures. It is to be understood and appreciated the herein description is meant to illustrate, and not limit, the scope of the present disclosure.

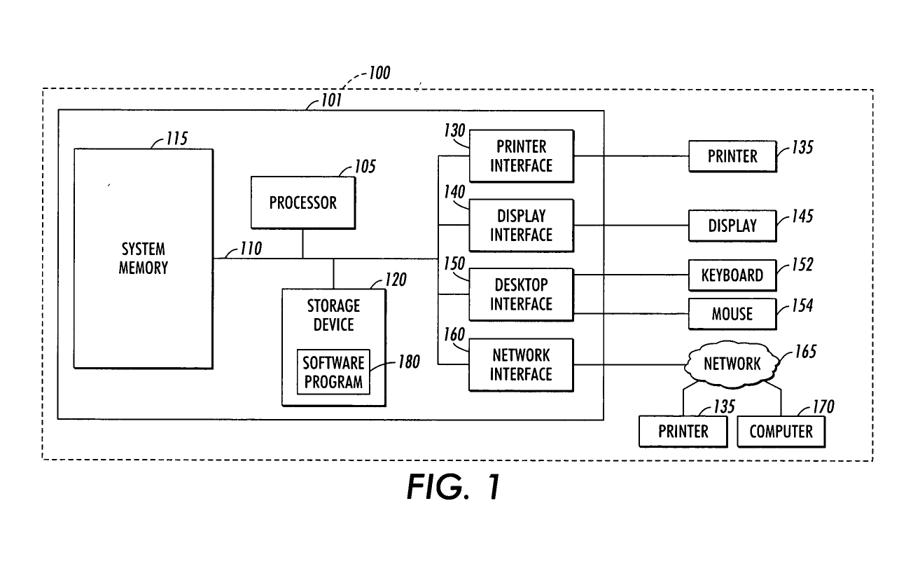

FIG. 1 illustrates a representative operating environment 100 for an exemplary embodiment in accordance with the present disclosure. Representative operating environment 100 includes computer 101 which can be a personal computer (PC) or a server, which further includes at least one system bus 110 which couples system components, including at least one processor 105; system memory 115 which includes random-access memory (RAM); at least one storage device 120, such as a hard disk, CD-ROM or DVD-ROM, or other non-volatile storage device, such as a flash memory device or USB memory stick; and input-output interfaces including printer interface 130, display interface 140, desktop interface 150 and network interface 160. System bus 110 may be any of several types of bus structures, including a memory bus or memory controller, a peripheral bus, and/or a local bus using any bus architecture such as PCI, USB or IEEE 1394 (Firewire). Desktop interface 150 may include an AT keyboard interface, a PS/2 keyboard interface, a PS/2 mouse interface, and/or a USB interface. Network interface may be a wired network interface such as a 100 Base-T Fast Ethernet interface, or a wireless network interface such as a wireless network interface compliant with the IEEE 802.11 standard.

Computer 101 may be operated in a networked environment via at least one network interface 160, wherein computer 101 is connected to remote devices by a data network, such as a local area network or the Internet, for the transmission and reception of data, including the download of software programs.

Representative operating environment 100 further includes printer 135, which can be locally coupled to computer 101 by printer interface 130, or by network interface 160 via network 165; display 145 which can be a cathode ray tube (CRT) display, liquid crystal display (LCD) or other suitable display; and input devices keyboard 152 and mouse 154.

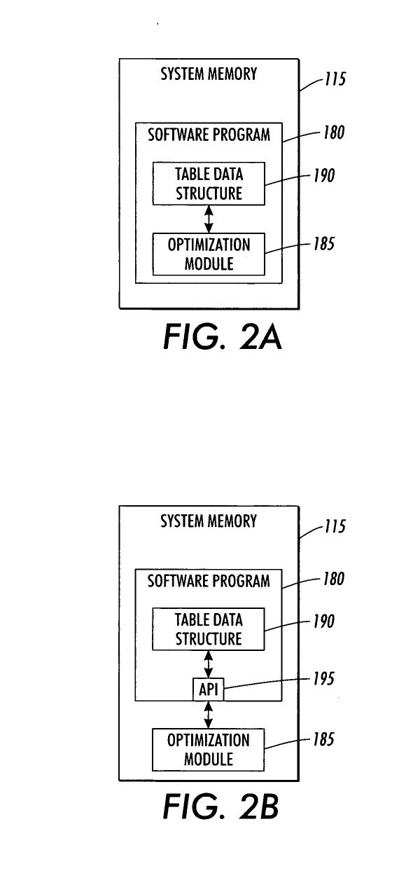

At least one software program 180 adapted to be executed on computer 101 is stored on storage device 120, or additionally or alternatively, on a remote network device such as a computer 170 which can be a PC, a web server, a file server, a storage array, or an application server. Software program 180 may include additional modules, routines, subroutines, objects, components, data structures, and other elements that will be familiar to the skilled artisan, that perform particular tasks. In response to commands entered into computer 101 via, for example, keyboard 152 and mouse 154, computer 101 can be caused to activate software program 180 which may be a spreadsheet, word processor, or dynamic table generator/formatter. Typically, upon activation software program 180 is loaded into system memory 115 from storage device 120 or remote computer 170 for execution by processor 105 to allow the user to create, manipulate and generate tabular displays of data. Referring now to FIGS. 2A and 2B, such tabular displays of data may be embodied, for example, as at least one table data structure 190 stored within system memory 115 (typically, within the application memory of software program 180), and rendered visually by printer 135 or display 145. The user may then wish to activate the optimization module 185, as will be further described hereinbelow, to optimize the tabular display's size in order to, for example, maximize the amount of information presented in a given area, enhance readability, to decrease rendering times, and to reduce production costs. Upon activation, optimization module 185 causes the optimization algorithm to be executed upon the tabular display of data.

In an embodiment, for example, where optimization module 185 is included within software program 180 as illustrated in FIG. 2A, optimization module 185 may operate directly upon table data structure 190. Additionally or alternatively, optimization module 185 configured as a software extension component may operate upon data structure 190 indirectly, through, for example, an application programming interface (API) 195, as illustrated in FIG. 2B, message queueing, or other suitable means. However, it is to be understood that an optimization module 185 that is included within software program 180, as illustrated in FIG. 2A, may also operate upon data structure 190 indirectly through an API or other suitable means and conversely, an optimization module 185 configured as a software extension component may operate directly upon table data structure 190, by directly reading and writing the application memory of software program 180, for example.

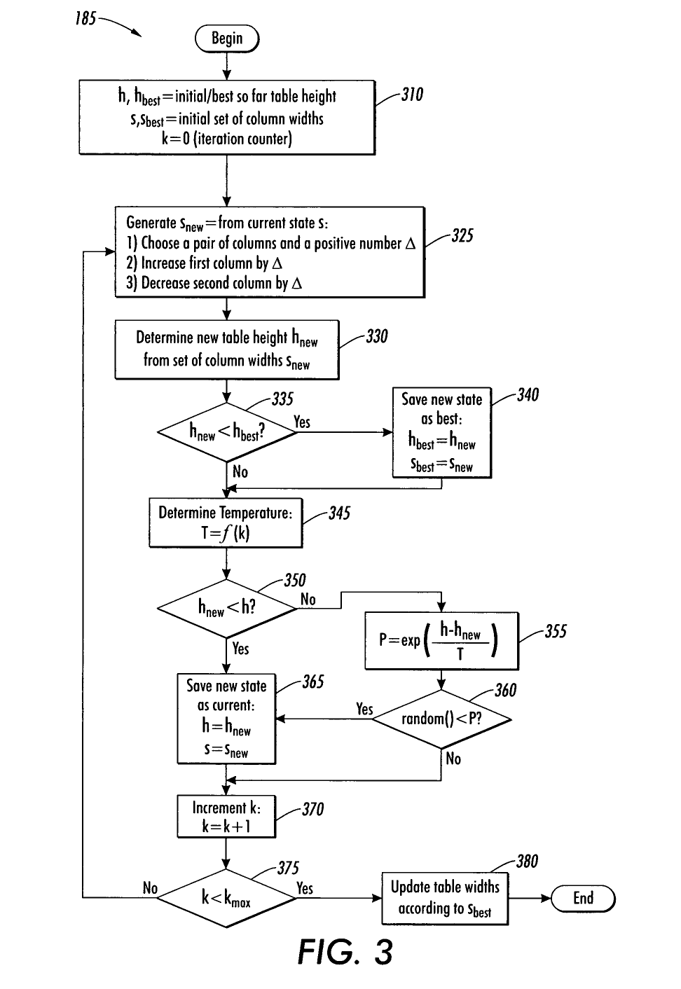

Referring now to FIG. 3, an embodiment of the optimization module 185 for optimizing table column widths using simulated annealing is presented in accordance with the present disclosure. It is to be understood that the labels and symbols used herein are illustrative in nature, and are not to be construed as limiting the scope of the present disclosure. In the step 310, the initial state of the tabular display is recorded wherein the initial height of the table is stored in h, which corresponds to the current height of the table, and also stored in h_{best}, which corresponds to the lowest-cost, or smallest, table height thus far identified. The initial set of column widths are stored in S, which corresponds to the current set of column widths, and also stored in S_{best}, which corresponds to the set of column widths having the lowest-cost table height. Additional initialization is performed wherein iteration counter k is cleared. Depending upon, for example, user preferences, additional initializations may be performed such as determining kₘₐₓ, corresponding to the maximum number of iterations to be performed; and T, which corresponds to the initial value of temperature; and delta, which is the amount of change (i.e., increase or decrease) in column width applied in the step 325 described below.

The reader will note that, when taken together, table height h and set of column widths S describe the current state of the tabular display. Similarly, h_{new} and S_{new} taken together describe a new state of the table, and h_{best} and S_{best} describe the best state which has been identified.

The step 325 is performed next, wherein a new set of columns widths S_{new} is generated by randomly selecting two columns from set S, increasing the size of the first column by delta, and decreasing the size of the second column by delta. Delta may be a fixed amount, as determined in initialization step 310, or it may be generated anew upon each iteration. In an embodiment, delta is a random number in the range of [c . . . min(w₁, w₂)-c] wherein c is the width of widest character in the set of current fonts in the tabular display (typically, the width of a capital “W”) and w₁, w₂ are the widths' of the two currently selected columns, respectively. Having now established a new set of columns S_{new}, new table weight h_{new} is determined in the step 330, and in the step 335, new table height h_{new} is compared to best table weight h_{best}. If the new table height is less than the best table height, that is, if h_{new} is less than h_{best}, then the step 340 is performed wherein the new state of the tabular display is saved as the best state, that is, h_{best} assumes the value of h_{new} and S_{best} assumes the value of S_{new}.

In the step 345, temperature T is determined as will be discussed in detail below. Processing continues with the step 350, wherein new table height h_{new} is compared to current table weight h. If h_{new} is less than h, meaning the new height is more optimal (smaller) than the current height, then the step 365 is performed wherein the new state is saved as the current state, that is, h assumes the value of h_{new} and S assumes the value of S_{new}. If however h_{hew} is not less than h, meaning the new height is the same as or less optimal (i.e. larger) than the current height, then transition probability P is determined in the steps 355. In the step 345, temperature T is determined in accordance with a temperature function f. In an embodiment, temperature T is calculated in as kₘₐₓ−k. Thereafter, in the step 355 transition probability P is determined. In another embodiment, temperature T assumes a starting value which decreases by a fixed amount each iteration that allows, for example, a 10% chance of a 10% increase in table height, or Tₛₜₐᵣₜ=h/23, and the transition probability is calculated in accordance with the formula

$$P = exp ( \frac{h - {h}_{new}}{T} ) .$$

Having established transition probability P, in the step 360 a random number in the range [0 . . . 1] is generated and compared to P. If the random number is less than P, then the step 365 is performed as described above, wherein the new state is saved as the current state.

In the step 370 iteration counter k is incremented, and in the following step 375, a determination is made as to whether the end state has been reached. If the end state has not yet been reached, a subsequent iteration proceeding from the step 325 commences, and processing continues in accordance with the present disclosure until the end state is reached. Various embodiments are contemplated, for example, where the end state is indicated when iteration counter k has reached kₘₐₓ; or where the end state is indicated by processing metrics, for example, by noting whether continued processing no longer results in useful reduction of table height; or by reaching a predetermined resource limit, such as processor time consumed, processor cycles used, memory used, or actual elapsed time. Such indicators may be considered either singly or in combination.

If the end state has been reached, optimization is complete, and the results are available in S_{best}, which represents the optimized set of column widths. In the step 380 the results are applied to the tabular display in accordance with the present disclosure.

It is contemplated that the steps of the method in accordance with the present disclosure can be performed in a different ordering than the ordering provided herein.

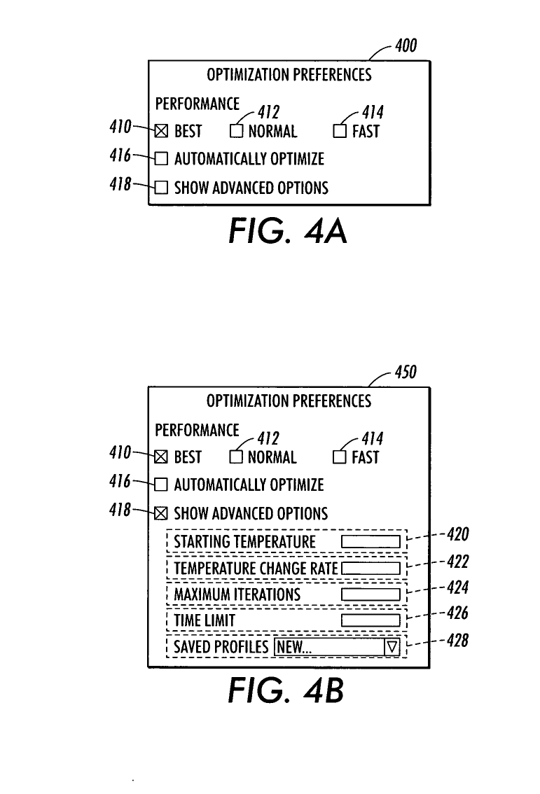

Turning now to FIGS. 4A and 4B, exemplary user interface 400 is shown which permits the user to choose optimization settings. Radio buttons 410, 412 and 414 provide to the user a means to select among preset optimization profiles in accordance with the present disclosure. Check box 416, when checked, indicates that the user has chosen automatic optimization whereby the optimization module is activated and executed whenever the content of the tabular display is changed. When check box 416 is unchecked, the optimization module is activated and executed manually by the user by, for example, selecting a menu item, clicking a button or a link, or by other suitable means.

Checking check box 418 caused advanced optimization options be presented as shown in user interface 450, whereby user interface elements 420, 422, 424, 426 can be used to manipulate starting temperature, the rate of change of temperature, the number of iterations to execute during each activation of the optimization module, and an optimization module processing time limit, respectively. User interface element 428 permits the user to save, recall and manage optimization profiles, using for, example, a drop-down menu. Other embodiments are envisioned within the scope of the present disclosure, wherein for example, more, less or different optimization parameters are presented to the user, or other suitable user interface elements are employed. In an embodiment, simplified or fanciful labels, such as “convergence”, are used in lieu of formal parameter designations, such as “temperature change rate.”

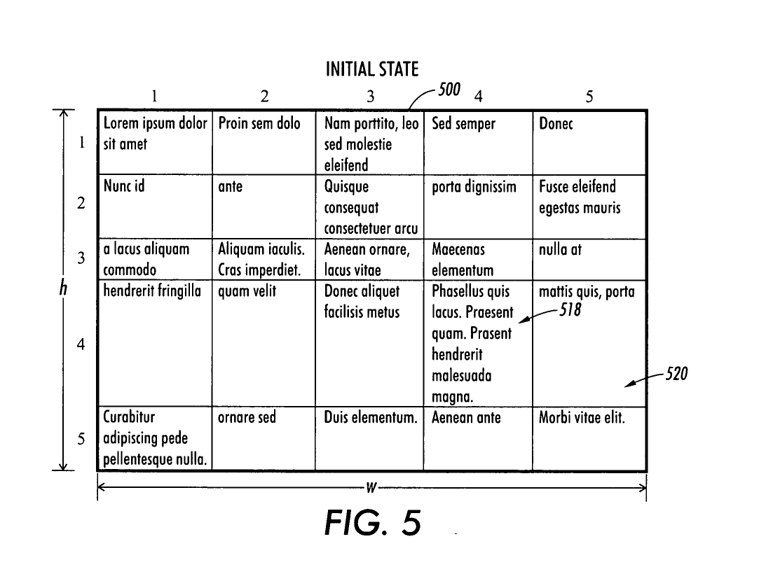

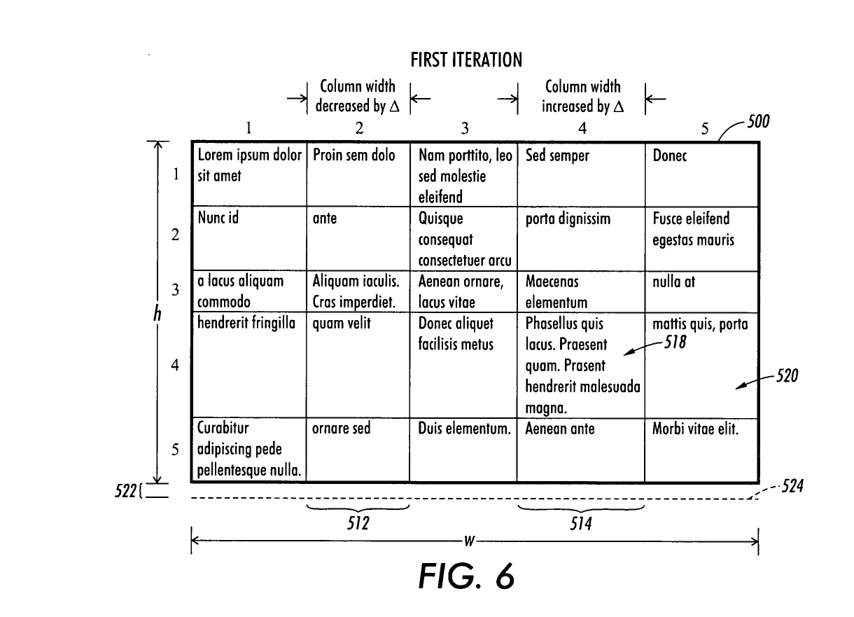

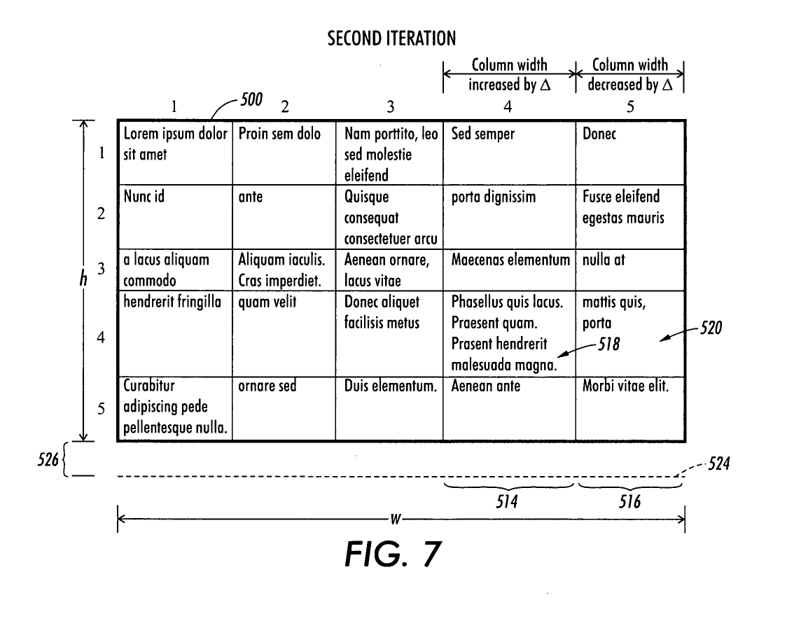

Examples of a table manipulation in accordance with the present disclosure are presented in FIGS. 5A, 5B and 5C. In FIG. 5A there is shown spreadsheet 500 in an initial state having five rows of differing heights, and five columns of equal width. Referring now to FIG. 5B, two columns 512 and 514 have been manipulated in a first iteration, where the width of column 512 has been decreased by an amount delta, and column the width of column 514 has been increased by delta and consequently, the text contained in cell 518 is now displayed in five lines, instead of six lines as in the initial state. The overall height h of the table is thus reduced in comparison to the initial state by an amount 522. This height reduction is further illustrated by noting the change in table height with respect to the initial bottom of the table as indicated by dotted line 524.

With reference now to FIG. 5C, two columns 514 and 516 have been manipulated in a second iteration wherein the width of column 514 has been increased by an amount delta, and column 516 has been decreased by delta. As can be seen, the text contained in cell 518 is now displayed in four lines rather than the five of the previous state causing a commensurate further reduction in table height as indicated by the amount 526 and again with reference to dotted line 524. Note that, while the narrowed width of column 516 now causes the text of cell 520 to be displayed in two lines, as compared to one line in the prior iteration, the height of cell 520 is still less than that of cell 518 (the long pole cell in this instance), and thus does not contribute to increased table height.

It is to be understood that the version of simulated annealing described herein is not the only global optimization algorithm which is suitable for table optimization. Embodiments are envisioned wherein alternative variants of simulated annealing, for example, quantum annealing or stochastic tunneling, as well as alternative global optimization techniques, such as tabu search, stochastic hill climbing, genetic algorithms, ant colony optimization, and/or the cross-entropy method can also be applied to table optimization.

It will be appreciated that various of the above-disclosed and other features and functions, or alternatives thereof, may be desirably combined into many other different systems or applications. Various presently unforeseen or unanticipated alternatives, modifications, variations or improvements therein may be subsequently made by those skilled in the art which are also intended to be encompassed by the following claims. The claims can encompass embodiments in hardware, software, or a combination thereof.

What is claimed is:

1. A method for minimizing the height of a tabular display, comprising the steps of:
(a) determining the initial height of a tabular display;
(b) selecting a first column and a second column of the tabular display and increasing the width of at least the first column by an amount and decreasing the width of at least the second column by a like amount;
(c) determining the new height of the tabular display and if the height has decreased, accepting the new set of column widths, or if the height has not decreased, accepting the new set of column widths according to a transition probability function; and
(d) iteratively repeating the steps (b) and (c) until an end state is reached.

2. The method in accordance with claim 1, further comprising establishing an initial value of temperature.

3. The method in accordance with claim 2, wherein the transition probability function provides for a decreasing probability of acceptance as the value of temperature decreases.

4. The method of claim 3, wherein successive iterations have a decreasing value of temperature.

5. The method in accordance with claim 1, further comprising establishing conditions indicating an end state.

6. The method in accordance with claim 6, wherein an end state is indicated after a fixed number of iterations have been performed.

7. The method in accordance with claim 6, wherein an end state is indicated after a fixed period of time has elapsed.

8. The method in accordance with claim 6, wherein an end state is indicated by processing metrics.

9. The method in accordance with claim 6, wherein an end state is indicated by reaching a predetermined resource limit.

10. A method for minimizing the height of a tabular display, comprising
arranging the widths of the columns of the tabular display in accordance with an optimization function, wherein the optimization function further comprises evaluating a cost function for a set of column widths;
determining an optimum set of columns widths by selecting an arrangement having a minimum cost from a group of possible sets of column widths; and
rendering the tabular display in accordance with the optimum set of column widths.

11. The method of claim 10, wherein the optimization function comprises selecting an optimum set of dimensions using at least one of simulated annealing, quantum annealing, stochastic tunneling, tabu search, stochastic hill climbing, genetic algorithms, ant colony or the cross-entropy method.

12. The method of claim 10, further comprising rendering the tabular display in response to a user input.

13. A system for minimizing the height of a tabular display, comprising:
at least one processor;
software for rendering the tabular display; and
an optimization module for minimizing the height of the tabular display by optimizing the widths of the columns of the tabular display.

14. The system according to claim 13, wherein the optimization module includes an optimization software program having a set of programmable instructions configured for execution by the at least one processor for minimizing the height of a tabular display.

15. The system according to claim 14, wherein the optimization software program is included in the software for rendering the tabular display.

16. The system according to claim 14, wherein the optimization software program is included in a software extension component.

17. The system according to claim 13, wherein the software for rendering the tabular display is one of a spreadsheet, a word processor, a page layout application, a dynamic table formatter, a web application, or a video compositing application.

18. The system according to claim 13, wherein the optimization module performs a method for minimizing the height of a tabular display, comprising:
arranging the widths of the columns of the tabular display in accordance with an optimization function, wherein the method further comprises evaluating a cost function for a set of column widths;
determining an optimum set of columns widths by selecting an arrangement having a minimum cost from a group of possible sets of column widths; and
rendering the tabular display in accordance with the optimum set of column widths.

19. The system according to claim 18, wherein the optimization function comprises selecting an optimum set of dimensions using at least one of simulated annealing, quantum annealing, stochastic tunneling, tabu search, stochastic hill climbing, genetic algorithms, ant colony or the cross-entropy method.

20. The system according to claim 13, wherein the optimization module operates in accordance with user-specified parameters.

21. A computer-readable medium storing a set of programmable instructions configured for being executed by at least one processor for performing a method for minimizing the height of a tabular display, comprising:
arranging the widths of the columns of the tabular display in accordance with an optimization function, wherein the method further comprises evaluating a cost function for a set of column widths;
determining an optimum set of columns widths by selecting an arrangement having a minimum cost from a group of possible sets of column widths; and
rendering the tabular display in accordance with the optimum set of column widths.

22. The computer-readable medium according to claim 21, wherein the optimization function comprises selecting an optimum set of dimensions using at least one of simulated annealing, quantum annealing, stochastic tunneling, tabu search, stochastic hill climbing, genetic algorithms, ant colony or the cross-entropy method.
